(19) United States
(12) Patent Application Publication
(10) Pub. No.: US 2004/0144196 A1
(43) Pub. Date: Jul. 29, 2004

(54) Steering wheel table

(76) Inventor: Donald Thomas, Zephyrhyill, FL (US)

Correspondence Address: DONALD THOMAS, 34335 Country Breeze Ave, Zephyrhills, FL, 33543, US

(21) Appl. No.: 10/218,867

(22) Filed: Jan. 29, 2003

(51) Int. Cl. B62D 1/06

(52) U.S. Cl. 74/558

(57) ABSTRACT

A steering wheel table that includes steering wheel connecting brackets that are securable to a tilt type steering wheel of a vehicle such as a motor home or the like which has a table surface portion connected by a hinge like device that is provided with a lockable angular adjustment mechanism for allowing the user to adjust the angle of the table portion to a substantially horizontal position and lock it in place so that the user can be seated at the driver's seat while parked and utilize the table portion for eating or performing other activities normally performed on a table.

### TECHNICAL FIELD

The present invention relates to vehicle accessories and more particularly to a steering wheel table device That is attachable to a tilt type steering wheel of a parked recreational vehicle, motor home or the like that includes a flat surface while supported By the angularly oriented steering wheel so that a person seated in the drivers seat can comfortably enjoy a meal or perform other tasks that require a flat surface such as writing out checks or the like; the steering wheel table includes three wheel mounting brackets, one fixed and two adjustable clamp type devices that lock to the wheel and a table portion which is connected by a hinge to the overall clamping device and which includes a lockable angular adjustment mechanism for allowing the user to raise one end of the table to an angle with respect to the steering wheel such that the table is substantially horizontal; the table portion can be provided with one or more cup holders if desired.

### BACKGROUND OF INVENTION

It is often desirable when traveling in a recreational vehicle/motor home or the like; for one or more of the occupants to eat or perform other tasks while seated in driving seat once parked. It would be a benefit, therefore, to these individuals to have A steering wheel table which could be attached to the steering wheel of the vehicle and which could be oriented to a horizontal position for supporting the elements of a meal or otherwise performing the function of a table.

### SUMMARY OF INVENTION

It is thus an object of the invention to provide a steering wheel table that Includes a flat surface while supported by the angularly oriented steering wheel so that a person seated in the driver's seat can comfortably enjoy a meal of perform other tasks that require a flat surface such as writing out checks or the like; the steering wheel table including three wheel mounting brackets which consist of one fixed and two adjustable clamp type devices that lock to the wheel and a table portion which is connected by a hinge to the clamp device and which includes a lockable angular adjustment mechanism for allowing the user to raise one end of the table to an angle with respect to the steering wheel such that the table is substantially horizontal; the table portion can be provided with one or more cup holders if desired.

Accordingly, a steering wheel table is provided. The steering wheel table includes a flat surface while supported by the angularly oriented steering wheel so that a person seated in the driver's seat can comfortably enjoy a meal or perform other tasks that require a flat surface such as writing out checks or the like; the steering require a flat surface such as writing out checks or the like; the steering wheel table including a wheel mounting bracket which has two adjustable clamp type devices and one fixed clamping device that locks to the wheel and a table portion which is connected by a hinge like device to the overall clamping device and which includes a lockable angular adjustment mechanism for allowing the user to raise one end of the table to an angle with respect to the steering wheel such that the table is substantially horizontal; the table portion can be provided with one or more cup holders if desired.

### BRIEF DESCRIPTION OF DRAWINGS

For a further understanding of the nature and objects the present invention, reference should be had to the following detailed description, taken in conjunction with the accompanying drawings, in which like elements are given the same or analogous reference numbers and wherein:

FIG. 1 is a front perspective view of an exemplary embodiment of the steering wheel table of the present invention.

FIG. 2 is a side plan view of the steering wheel table of the present invention.

FIG. 3 is an underside view of an exemplary embodiment of the clamping device specific to the steering wheel table of the present invention.

### EXEMPLARY EMBODIMENTS

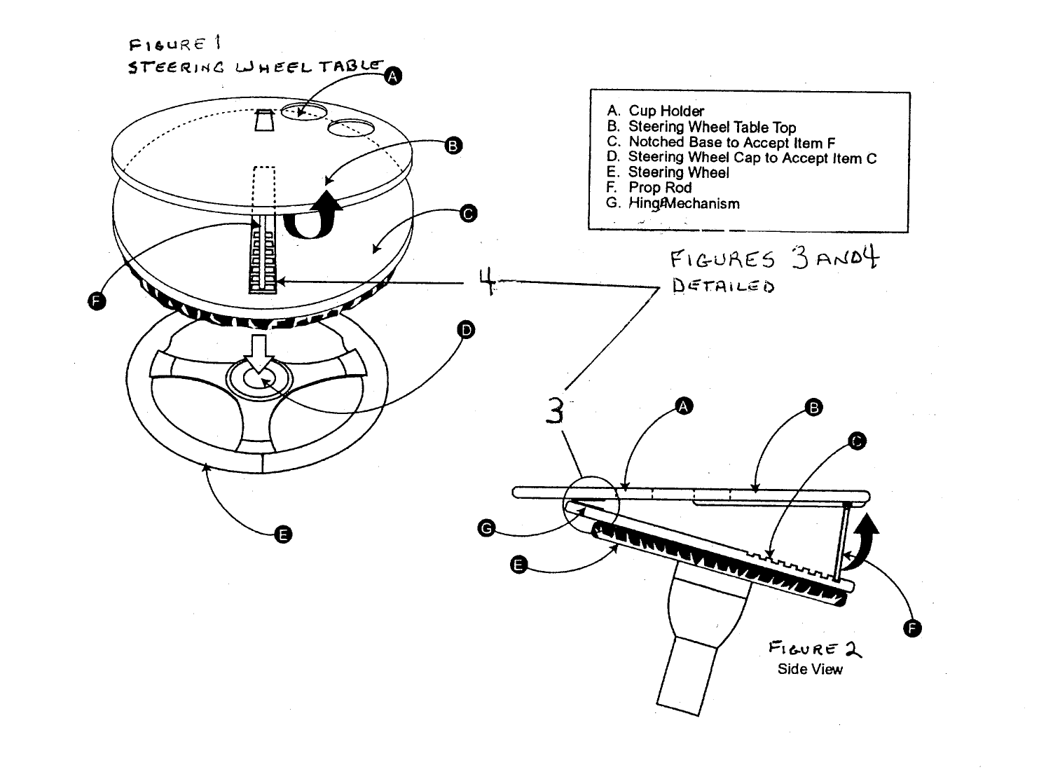

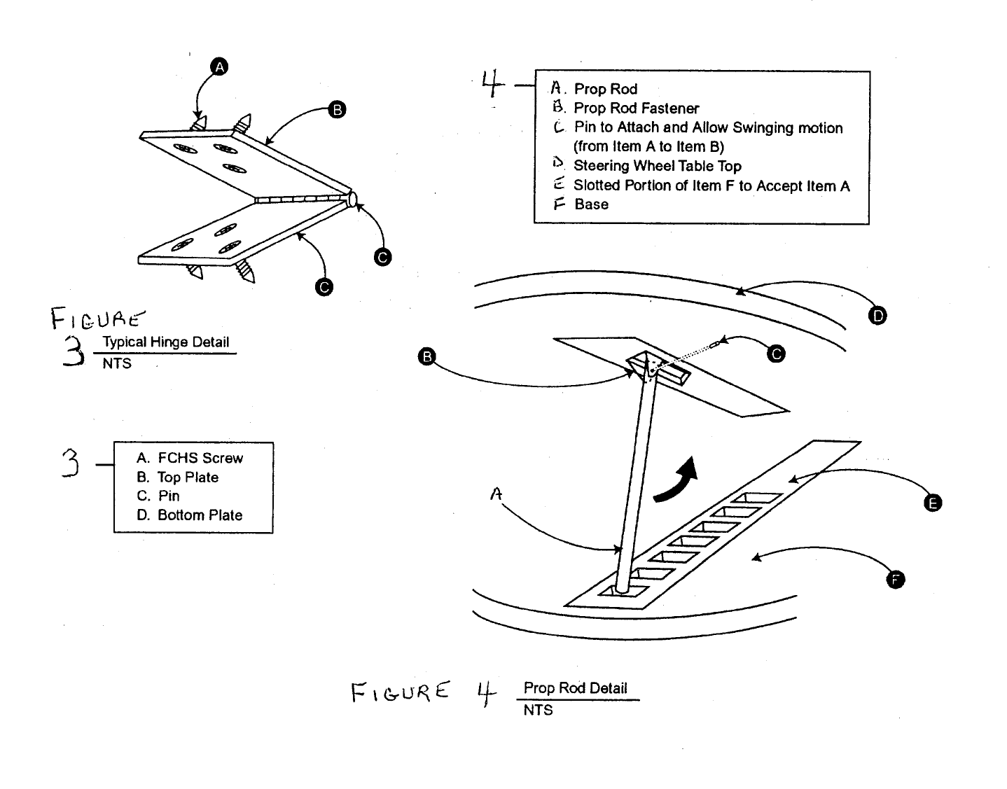

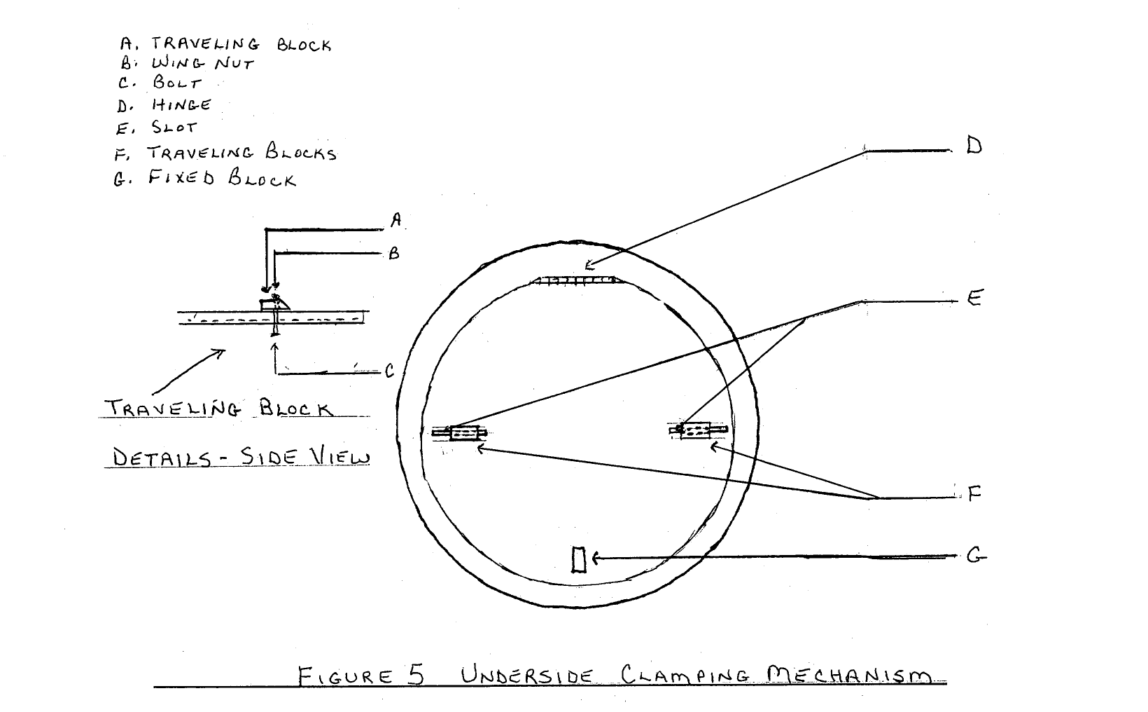

FIGS. 1, 2, 3, 4 and 5 show various aspects of a steering wheel table device that is generally designated 1 adapted for use in connection with the steering wheel E of a parked recreational vehicle, motor home or the like. Steering wheel table device 1 includes a wheel mounting bracket that has a table portion B connected by a hinge like device G detailed in FIG. 3 to a notched base C. The incline of table portion B is adjustable by lockable angular adjustment mechanism C which includes a number of notched slots formed in mounting bracket and a pivoting support bar F that pivots at a top connection all detailed in FIG. 4 with table portion B to the desired angle. In this embodiment table portion B is provided with two cup holders A for holding beverages and the like.

It is noted that the embodiment of the steering wheel table described herein in detail for exemplary purposes is of course subject to many different variations in structure, design, application and methodology. Because many varying and different Embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1: What I claim as my invention is a steering wheel table.

2: It is easily attachable to a tilt type steering wheel of a parked vehicle.

3: It easily adjusts to become in a substantially horizontal position for practical or decorative purposes.
